(19) United States
(12) Patent Application Publication
(10) Pub. No.: US 2018/0364902 A1
(43) Pub. Date: Dec. 20, 2018

(54) Projection Tablet Personal Computer

(71) Applicant: JING MOLD ELECTRONICS TECHNOLOGY (SHENZHEN) CO., LTD., Shenzhen City (CN)

(72) Inventor: Chinsung Yang, Shenzhen City (CN)

(21) Appl. No.: 15/743,279

(22) PCT Filed: Aug. 3, 2017
(86) PCT No.: PCT/CN2017/095887

§ 371 Date: Jan. 10, 2018

(30) Foreign Application Priority Data
Aug. 4, 2016 (CN) 201620839344.6

(51) Int. Cl. G06F 3/0488; G06F 3/0354; G06F 3/041; G06F 1/16

(52) U.S. Cl. CPC G06F 3/04883; G06F 1/169; G06F 3/0412; G06F 3/03545

(57) ABSTRACT

The present invention relates to a projection tablet personal computer. The projection tablet personal computer includes a flat casing, a tablet personal computer mainboard, a handwriting board circuit module, a handwriting screen, a projection module and a lens. The lens is mounted on a surface of the casing. The handwriting screen is mounted on the upper surface of the casing. The tablet personal computer mainboard, the handwriting board circuit module and the projection module are mounted in the casing. The tablet personal computer mainboard is electrically connected with the handwriting board circuit module and the projection module. The projection tablet personal computer of the present invention utilizes a handwriting board as an input device to reduce the cost thereof. The projection tablet personal computer integrates the function of a projector and provides multiple image transmission modes, thereby being used flexibly and conveniently and being suitable for many occasions.

### FIELD OF THE INVENTION

The present invention relates to the field of electronic technology, particularly relates to a projection tablet personal computer.

### BACKGROUND OF THE INVENTION

A tablet personal computer is a small, portable personal computer with a touch screen as a basic input device. Users can input information by built-in handwriting recognition, virtual keyboard on the screen, voice recognition, or a real keyboard (if the tablet personal computer is provided with a real key board). Conventional tablet personal computers are mainly divided into ARM architecture (representative products are iPad and Android tablet personal computers) and X86 architecture (a representative product is Surface Pro). The tablet personal computers of the latter X86 architecture generally adopt an Intel processor and Windows operation system, which have the integrity function of a computer and a tablet personal computer. A tablet personal computer is mainly composed of a tablet personal computer mainboard and a touch screen. The tablet personal computer mainboard mainly has a processor, a flash memory, a dynamic random access memory, a lithium battery, etc. mounted thereon, and is provided with various peripheral circuits.

A handwriting board is usually used as an input device for a computer, of which the function is similar to a keyboard. The handwriting board basically is limited to input text or draw and has some functions of a mouse. Generally a special handwriting pen or a finger is used to write text on a handwriting screen of the handwriting board. The handwriting board will record the track of the handwriting pen or the finger by various methods, and is connected to a computer via a signal line. Then the track will be recognized as text or drawing. Conventional handwriting boards are mainly divided into resistance handwriting board, capacitive handwriting board and electromagnetic handwriting board. A handwriting board is mainly composed of a handwriting board circuit module and a handwriting screen. According to the type of handwriting board, a corresponding handwriting pen can be further equipped.

A projector which is usually used to project an image or video onto a screen needs to be connected to a computer to play a corresponding video signal while being used. The projector can be widely used in homes, offices, schools, entertainment venues and so on. The conventional projector is mainly composed of a projection module and a lens, and receives a video signal from a computer via a signal line to display.

The conventional projector generally works with an additional computer cooperatively. Images can be provided by the computer and operations can be performed by the accessary input devices of the computer, such as a keyboard or a mouse, which results in inconvenience in use and high cost. The conventional handwriting board as an input device also need to work with a computer cooperatively.

### SUMMARY OF THE INVENTION

Accordingly, an object of the present invention is to provide a projection tablet personal computer which integrates the functions of a handwriting board and a projector.

To achieve the above mentioned object, a projection tablet personal computer of the present invention includes a flat casing, a tablet personal computer mainboard, a handwriting board circuit module, a handwriting screen, a projection module and a lens. The lens is mounted on a surface of the casing. The handwriting screen is mounted on the upper surface of the casing. The tablet personal computer mainboard, the handwriting board circuit module and the projection module are mounted in the casing. The tablet personal computer mainboard is electrically connected with the handwriting board circuit module and the projection module.

The handwriting board circuit module is an electromagnetic handwriting board circuit module, a resistance handwriting board circuit module, or a capacitive handwriting board circuit module.

The projection tablet personal computer further comprises an electromagnetic resonance handwriting pen, and the handwriting board circuit module is an electromagnetic handwriting board circuit module.

The projection module is a digital-optical processing projection module.

The tablet personal computer mainboard is provided with a functional interface for connecting with an outer monitor.

The tablet personal computer mainboard is provided with a wireless fidelity module for connecting with an outer monitor via wireless image transmission method.

The projection tablet personal computer further comprises a battery module.

The tablet personal computer mainboard is provided with a processor.

The tablet personal computer mainboard is provided with a dynamic random access memory.

The tablet personal computer mainboard is provided with a flash memory.

In summary, the projection tablet personal computer of the present invention utilizes a handwriting board as an input device to reduce the cost thereof. The projection tablet personal computer integrates the function of a projector and provides multiple image transmission modes, thereby being used flexibly and conveniently and being suitable for many occasions.

### BRIEF DESCRIPTION OF THE DRAWINGS

The technical solution and the beneficial effects of the present invention can be easily understood from the following detailed description of embodiments with reference to the accompanying figures.

In the figures:

FIG. 1 is a schematic view of the external structure of the projection tablet personal computer of the present invention in accordance with a preferred embodiment;

FIG. 2 is an exploded view of the projection tablet personal computer of the present invention in accordance with the preferred embodiment;

FIG. 3 is a diagram of the projection tablet personal computer of the present invention in accordance with the preferred embodiment showing circuit connection relationship.

### DESCRIPTION OF THE PREFERRED EMBODIMENT

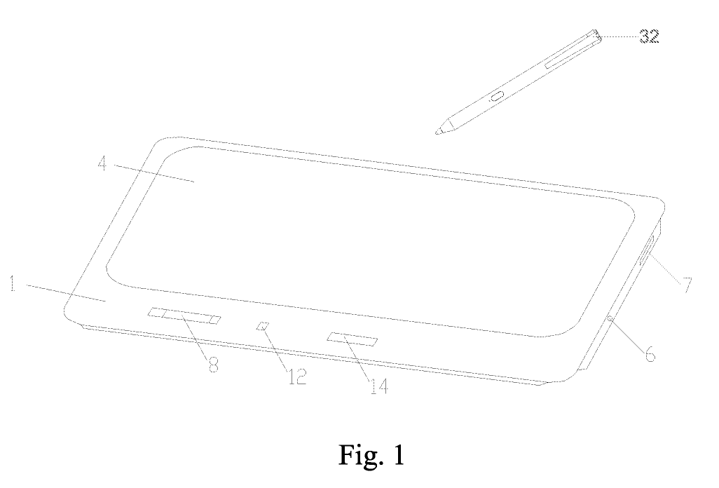

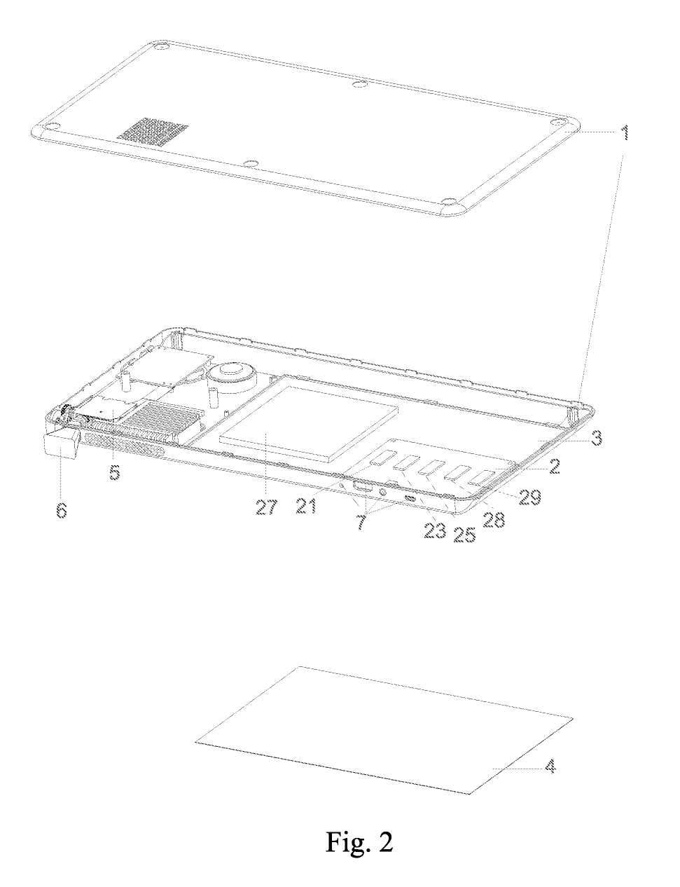

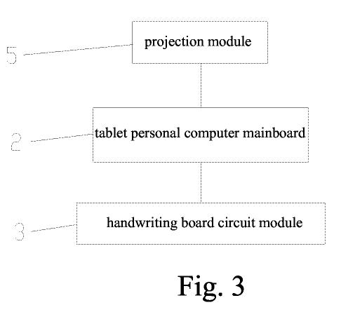

As shown in FIGS. 1 to 3, a projection tablet personal computer of the present invention mainly comprises: a flat casing 1, a tablet personal computer mainboard 2, a handwriting board circuit module 3, a handwriting screen 4, a projection module 5 and a lens 6. The lens 6 is mounted on a surface of the casing 1. In the preferred embodiment, the lens 6 is mounted on a side edge. The handwriting screen 4 is mounted on the upper surface of the casing 1. The tablet personal computer mainboard 2, the handwriting board circuit module 3 and the projection module 5 are mounted in the casing 1. The tablet personal computer mainboard 2 is electrically connected with the handwriting board circuit module 3 and the projection module 5.

In the preferred embodiment, the projection tablet personal computer adopts X86 architecture and runs Windows system. On the tablet personal computer mainboard 2, a processor (CPU) 21 such as Intel® Cherry Trail-T Z8300, a dynamic random access memory (DRAM) 23 such as a 4 GB LPDDR3 and a flash memory 25 such as a 32 GB eMMC (Embedded Multi Media Card) are provided. The tablet personal computer mainboard 2 is also provided with a battery module 27 for supplying power, such as a lithium battery (for example, battery specification: 7500 mAh, 3.7V). The battery module 27 is electrically connected to the tablet personal computer mainboard 2. The tablet personal computer mainboard 2 can also be provided with a Bluetooth (BT) module 28, such as BT4.0, and a wireless fidelity (Wi-Fi) module 29, such as IEEE 802.11b/g/n.

The side of the casing 1 are provided with various functional interfaces 7, which may comprise, for example, a USB3.0 Full Size/micro interface, a Micro HDMI interface, a Micro SD card slot (for example, maximum supportability 128 GB), a DC jack (micro USB interface being available), an ear jack (for example, specification: 3.5 mm) and so on. The functional interfaces 7 are electrically connected to the tablet personal computer mainboard 2. The surface of the case 1 is further provided with function keys 8, which may include volume key of the projection tablet personal computer, power key of the projection tablet personal computer and so on. The function keys 8 are electrically connected to the tablet personal computer mainboard 2. The surface of the casing 1 can also be provided with a LED light 12 for showing working status of the projection tablet personal computer and a speaker 14 for pronouncing sound.

The handwriting board circuit module 3 and the handwriting screen 4 realize the function of a handwriting board to be used as an input device to control the whole projection tablet personal computer. The handwriting board circuit module 3 can be an electromagnetic handwriting board circuit module, a resistance handwriting board circuit module, or a capacitive handwriting board circuit module. In the preferred embodiment, an electromagnetic handwriting board circuit module is adopted, and a corresponding electromagnetic resonance (EMR) handwriting pen 32 is also provided. When using the electromagnetic resonance handwriting pen 32 to control the projection tablet personal computer, a cursor is displayed on the screen to show the user where is in action. The position of the electromagnetic resonance handwriting pen 32 may be calculated via conventional algorithms.

The projection module 5 and the lens 6 realize the function of a projector to output images as a built-in projector of the projection tablet personal computer. By using the built-in projector to display images onto a wall or a partition wall of an office, the user only needs to carry a projection tablet personal computer of the present invention but does not need to carry a monitor. The projection module 5 may be a digital-optical processing (DLP) projection module, and may have the resolution of WVGA (Wide Video Graphics Array).

A user can also use a Mini HDMI connector (that is the functional interface 7) provided on the tablet personal computer mainboard 2 to connect the projection tablet personal computer with an outer monitor via a HDMI line. Thus a perfect audiovisual performance can be provided. By the wireless fidelity module 29 provided on the tablet personal computer mainboard 2, a user can also connect the projection tablet personal computer with an outer monitor by using a software with wireless image transmission (Miracast™) technology, whereby the user can wirelessly use the projection tablet personal computer of the present invention.

In summary, the projection tablet personal computer of the present invention utilizes a handwriting board as an input device to replace a touch screen thereby reducing cost thereof. The projection tablet personal computer integrates the function of a projector and provides multiple image transmission modes, thereby being used flexibly and conveniently and being suitable for many occasions.

Although the present invention has been described in detail with above said embodiments, but it is not to limit the scope of the invention. So, all the modifications and changes according to the characteristic and spirit of the present invention are involved in the protected scope of the invention.

What is claimed is:

1. A projection tablet personal computer comprising a flat casing, a tablet personal computer mainboard, a handwriting board circuit module, a handwriting screen, a projection module and a lens; the lens being mounted on a surface of the casing, the handwriting screen being mounted on the upper surface of the casing; the tablet personal computer mainboard, the handwriting board circuit module and the projection module being mounted in the casing, and the tablet personal computer mainboard being electrically connected with the handwriting board circuit module and the projection module.

2. The projection tablet personal computer of claim 1, wherein the handwriting board circuit module is an electromagnetic handwriting board circuit module, a resistance handwriting board circuit module, or a capacitive handwriting board circuit module.

3. The projection tablet personal computer of claim 1, further comprising an electromagnetic resonance handwriting pen, and the handwriting board circuit module being an electromagnetic handwriting board circuit module.

4. The projection tablet personal computer of claim 1, wherein the projection module is a digital-optical processing projection module.

5. The projection tablet personal computer of claim 1, wherein the tablet personal computer mainboard is provided with a functional interface for connecting with an outer monitor.

6. The projection tablet personal computer of claim 1, wherein the tablet personal computer mainboard is provided with a wireless fidelity module for connecting with an outer monitor via wireless image transmission method.

7. The projection tablet personal computer of claim 1, further comprising a battery module.

8. The projection tablet personal computer of claim 1, wherein the tablet personal computer mainboard is provided with a processor.

9. The projection tablet personal computer of claim 1, wherein the tablet personal computer mainboard is provided with a dynamic random access memory.

10. The projection tablet personal computer of claim 1, wherein the tablet personal computer mainboard is provided with a flash memory.
